(19) United States
(12) Patent Application Publication
(10) Pub. No.: US 2009/0012322 A1
(43) Pub. Date: Jan. 8, 2009

(54) Alkoxysilanes and Use Thereof In Alkoxysilane Terminated Prepolymers

(75) Inventors: Andreas Bockholt, Munchen (DE); Volker Stanjek, Munchen (DE); Richard Weidner, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: Consortium fur elektrochemische Industrie GmbH

(21) Appl. No.: 10/595,646

(22) PCT Filed: Oct. 7, 2004
(86) PCT No.: PCT/EP04/11215

§ 371 Date: May 2, 2006

(30) Foreign Application Priority Data
Nov. 6, 2003 (DE) 103 51 802.9

(51) Int. Cl. C07F 7/10

(52) U.S. Cl. 556/421; 556/418

(57) ABSTRACT

Storage stable aspartyl α-aminosilanes are useful in applications where reactive α-aminosilanes have been used. Alkoxysilyl-terminated prepolymers are easily prepared therefrom and offer high reactivity to water or atmospheric moisture, even when the alkoxy groups are ethoxy groups.

The invention relates to aminomethyl-functional alkoxysilanes, to prepolymers prepared from these silanes, and to compositions comprising said prepolymers.

Prepolymer systems which possess reactive alkoxysilyl groups have been known for a long time and are widely used for producing elastic sealants and adhesives in the industrial and construction sectors. In the presence of atmospheric humidity and appropriate catalysts these alkoxysilane-terminated prepolymers are capable even at room temperature of undergoing condensation with one another, with the elimination of the alkoxy groups and the formation of an Si—O—Si bond. Consequently, these prepolymers can be used, among other things, as one-component systems, which possess the advantage of ease of handling, since there is no need to measure out and mix in a second component.

A further advantage of alkoxysilane-terminated prepolymers lies in the fact that curing is not accompanied by release either of acids or of oximes or amines. Moreover, in contrast to isocyanate-based adhesives or sealants, no CO₂ is formed either, which as a gaseous component can lead to bubbles forming. In contrast to isocyanate-based systems, alkoxysilane-terminated prepolymer mixtures are also toxicologically unobjectionable in each case. Depending on the amount of alkoxysilane groups and their structure, the curing of this type of prepolymer is accompanied by the formation principally of long-chain polymers (thermoplastics), relatively wide-meshed three-dimensional networks (elastomers) or else highly crosslinked systems (thermosets).

Alkoxysilane-functional prepolymers may be composed of different units. They customarily possess an organic backbone: in other words they are composed, for example, of polyurethanes, polyethers, polyesters, polyacrylates, polyvinyl esters, ethylene-olefin copolymers, styrene-butadiene copolymers or polyolefins, described inter alia in U.S. Pat. No. 6,207,766 and U.S. Pat. No. 3,971,751. In addition, however, systems whose backbone is composed entirely or at least partly of organosiloxanes are also widespread, and are described inter alia in U.S. Pat. No. 5,254,657.

Of key importance in the prepolymer preparation, however, are the monomeric alkoxysilanes, via which the prepolymer is equipped with the necessary alkoxysilane functions. Here it is possible in principle to employ any of a very wide variety of silanes and coupling reactions: for example, an addition reaction of Si—H-functional alkoxysilanes with unsaturated prepolymers, or a copolymerization of unsaturated organosilanes with other unsaturated monomers.

In another process, alkoxysilane-terminated prepolymers are prepared by reacting OH-functional prepolymers with isocyanate-functional alkoxysilanes. Systems of this kind are described for example in U.S. Pat. No. 5,068,304. The resulting prepolymers are often notable for particularly positive properties, such as very good mechanical properties of the fully cured compositions, for example. Disadvantages, however, include the inconvenient and costly preparation of the isocyanate-functional silanes, and the fact that from a toxicological standpoint these silanes are extremely objectionable.

A preparation process for alkoxysilane-terminated prepolymers that is often more favorable here is one which starts from polyols, such as from polyether or polyester polyols. These polyols react in a first step with an excess of a di- or polyisocyanate. Subsequently the resultant isocyanate-terminated prepolymers are reacted with an amino-functional alkoxysilane to form the desired alkoxysilane-terminated prepolymer. Systems of this kind are described for example in EP 1 256 595 and EP 1 245 601. Advantages of this system are, on the one hand, the particularly positive properties of the resultant prepolymers, such as the very good tensile strength of the fully cured compositions, for example. On the other hand, the amino-functional silanes needed as reactants are largely unobjectionable from a toxicological standpoint and are available by means of simple and inexpensive processes.

A disadvantage of the majority of known systems and those used at present, however, is their no more than moderate reactivity with respect to moisture, not only in the form of atmospheric humidity but also in the form of existing or added water. In order to achieve a sufficient cure rate at room temperature it is therefore vital to add a catalyst. The main reason why this presents problems is that the organotin compounds commonly employed as catalysts are toxicologically objectionable. Moreover, the tin catalysts often still contain traces of highly toxic tributyltin derivatives.

A particular problem is the relatively low reactivity of the alkoxysilane-terminated prepolymer systems if the terminations used are not methoxysilyls but instead the even less reactive ethoxysilyls. Ethoxysilyl-terminated prepolymers specifically, however, would be particularly advantageous in many cases, since their curing is accompanied by the release only of ethanol as a cleavage product.

In order to avoid problems with toxic tin catalysts, attempts have already been made to look for tin-free catalysts. Consideration might be given here, in particular, to titanium catalysts, such as titanium tetraisopropoxide or bis(acetylacetonato)diisobutyl titanate, which for example are described in EP 0 885 933. These titanium catalysts, however, possess the disadvantage that they cannot be used together with numerous nitrogen compounds, since the latter act here as catalyst poisons. The use of nitrogen compounds, as adhesion promoters for example, would nevertheless be desirable in many cases. Moreover, nitrogen compounds, aminosilanes for example, serve in many cases as reactants in the preparation of the silane-terminated prepolymers.

Accordingly, alkoxysilane-terminated prepolymer systems of the kind described, for example, in DE 101 42 050 or DE 101 39 132 may represent a great advantage. A feature of these prepolymers is that they contain alkoxysilyl groups separated only by one methyl spacer from a nitrogen atom having a free electron pair. As a result, these prepolymers possess extremely high reactivity with respect to (atmospheric) humidity, and accordingly can be processed to prepolymer blends which are able to manage without metallic catalysts and yet cure at room temperature with in some cases extremely short tack-free times and/or at very high speed. Since, therefore, these prepolymers possess an amine function positioned α to the silyl group, they are also referred to as α-alkoxysilane-terminated prepolymers.

These α-alkoxysilane-terminated prepolymers are typically prepared by the reaction of an α-aminosilane, i.e., an aminomethyl-functional alkoxysilane, with an isocyanate-functional prepolymer or an isocyanate-functional precursor of the prepolymer. Common examples of α-aminosilanes are N-cyclohexylaminomethyl-trimethoxysilane, N-ethylaminomethyltrimethoxysilane, N-cyclohexylaminomethylmethyldimethoxysilane, etc.

A critical disadvantage of these α-alkoxysilane-functional systems is the no more than moderate stability of the α-aminosilanes required for their synthesis. Stability problems of comparable magnitude are unknown in the case of the conventional γ-amino-propylalkoxysilanes.

This instability becomes marked in the presence of alcohol or water. For example, aminomethyltrimethoxysilane is broken down quantitatively into tetramethoxysilane within just a few hours in the presence of methanol. With water it reacts to form tetrahydroxysilane and/or higher condensation products of that silane. Correspondingly, aminomethylmethyldimethoxysilane reacts with methanol to give methyltrimethoxysilane and with water to give methyltrihydroxysilane and/or higher condensation products of that silane. Somewhat more stable are N-substituted α-aminosilanes, e.g., N-cyclohexylaminomethylmethyldimethoxysilane. Yet in the presence of traces of catalysts or basic contamination even this silane is broken down quantitatively to methyltrimethoxysilane in the presence of methanol and to methyltrihydroxysilane with water, within just a few hours. The other N-substituted α-aminosilanes with a secondary nitrogen atom, corresponding to the prior art, also display the same breakdown reactions.

However, even in the absence of methanol or water, these α-aminosilanes are only of moderate stability. Thus, especially at elevated temperatures and in the presence of catalysts or catalytically active impurities, there may likewise be decomposition of the α-silanes.

Only α-aminosilanes with a tertiary nitrogen atom are largely stable. However, owing to the absent NH function, these silanes can no longer be processed with isocyanate-functional precursors to form α-alkoxysilane-functional prepolymers. Likewise of comparative stability are the various N-phenylaminomethylalkoxysilanes, which are in each case only of weak basicity. Yet these compounds too are generally unsuitable for use in α-silane-terminated prepolymers, since they react with the isocyanatefunctional prepolymer precursors to form aromatically substituted urea units. The latter are extremely unstable with respect to UV radiation, since they are able to enter into a photo-Fries rearrangement, forming aniline derivatives which are very quickly oxidized in the presence of oxygen. This leads within a very short time to severe discoloration in the corresponding compositions.

The no more than moderate stability of the α-aminosilanes may have deleterious consequences, since these compounds may undergo at least partial decomposition even under the reaction conditions of the prepolymer synthesis. This can lead to a deterioration in the prepolymer properties.

The object was therefore to provide aminomethylfunctional alkoxysilanes having a secondary nitrogen atom and an improved stability, and high-quality prepolymers prepared therewith.

The invention provides aminomethyl-functional alkoxysilanes (A1) of the general formula [1]

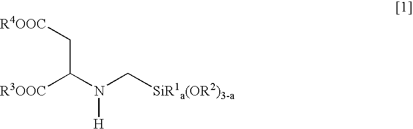

where
R¹ is an optionally halogen-substituted hydrocarbon radical,
R² is an alkyl radical having 1-6 carbon atoms or a ω-oxaalkyl-alkyl radical having in all 2-10 carbon atoms,
R³ is an optionally substituted hydrocarbon radical,
R⁴ is an optionally substituted hydrocarbon radical, and
a is 0, 1 or 2.

The invention is based on the discovery that the silanes (A1) are distinguished by a markedly increased stability. For example, methanolic solutions of the silanes (10% by weight) exhibit substantially higher stabilities than conventional α-aminomethylsilanes. In other words, the silanes decompose markedly more slowly under these conditions, which is manifested in, among other things, the substantially higher half-life of these silanes. The NMR-spectroscopically detected decomposition of the α-aminomethylsilanes indicates an Si—C cleavage.

Typical half-lives for the silanes (A1) are as follows:

diethyl N-methyl(dimethoxymethylsilyl)aspartate: t_{1/2}=5 weeks
diethyl N-methyl(diethoxymethylsilyl)aspartate: t_{1/2}=4 weeks
diethyl N-methyl(trimethoxysilyl)aspartate: t_{1/2}=4 weeks

Conventional aminomethyl-functional alkoxysilanes with a primary or secondary amine function have largely undergone decomposition after just a short time under the same conditions. A number of typical half-lives of conventional α-aminosilanes are listed below:

aminomethylmethyldimethoxysilane: t_{1/2}=6 h
cyclohexylaminomethylmethyldimethoxysilane: t_{1/2}=1 week
aminomethyltrimethoxysilane: t_{1/2}=19 h
cyclohexylaminomethyltrimethoxysilane: t_{1/2}=3 days
isobutylaminomethyltrimethoxysilane: t_{1/2}=1 week

The hydrocarbon radicals R¹, R³, and R⁴ preferably have 1 to 20, in particular not more than 10, carbon atoms. The hydrocarbon radicals R¹, R³, and R⁴ are preferably unsubstituted. The hydrocarbon radicals R¹, R³, and R⁴ are preferably alkyl, cycloalkyl, alkenyl or aryl radicals.

Preferred radicals R¹ are methyl, ethyl or phenyl groups. The radicals R² are preferably methyl or ethyl groups, while preferred radicals R³ and R⁴ are alkyl radicals having 1-20, more preferably having 1-5, carbon atoms, especially methyl, ethyl or propyl groups.

The silanes (A1) are prepared preferably by the reaction of suitable aminomethylalkoxysilanes with maleic esters. This can take place both with and without catalyst, though preferably the reaction is carried out without catalyst. The reaction can be carried out either in bulk or in a solvent. Preferably, however, the reaction takes place in bulk.

A further possible preparation pathway for the silanes (A1) is the reaction of D- or L-aspartic esters or their racemates with chloromethylalkoxysilanes.

The invention further provides a process for preparing prepolymers (A) having end groups of the general formula [2]

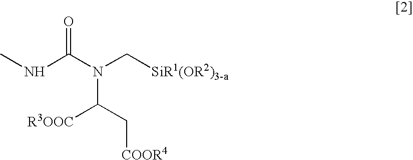

where R¹, R², R³, R⁴, and a are as defined for the general formula [1],
by reacting alkoxysilanes (A1) of the general formula [1]
a) with isocyanate-terminated prepolymer (A2), or
b) with prepolymer (A) precursor containing NCO groups to give precursor containing end groups of the general formula [2], the precursor containing end groups of the general formula [2] being reacted in further steps to give the finished prepolymer (A).

In this case the proportions of the individual components are chosen preferably so that all of the isocyanate groups present in the reaction mixture are consumed by reaction. The resultant prepolymers (A) accordingly, are preferably isocyanate-free.

The invention also provides the prepolymers (A).

In the reaction of the silanes (A1) to silane—terminated prepolymers (A) they are reacted preferably with isocyanate-terminated prepolymers (A2). The latter are obtainable, for example, by a reaction of one or more polyols (A21) with an excess of di- or polyisocyanates (A22).

As will be appreciated, the sequence of the reaction steps in this case can also be reversed, i.e., in a first reaction step the silanes (A1) are reacted with an excess of one or more di- or polyisocyanates (A22) and only in the second reaction step is the polyol component (A21) added.

As polyols (A21) for preparing the prepolymers (A) it is possible in principle to use all polyols having an average molecular weight Mn of 1000 to 25 000. These may be, for example, hydroxyl-functional polyethers, polyesters, polyacrylates and polymethacrylates, poly—carbonates, polystyrenes, polysiloxanes, polyamides, polyvinyl esters, polyvinyl hydroxides or polyolefins such as polyethylene, polybutadiene, ethylene-olefin copolymers or styrene-butadiene copolymers.

Preference is given to using polyols (A21) having a molecular weight Mn of 2000 to 25 000, more preferably of 4000 to 20 000. Particularly suitable polyols (A21) are aromatic and/or aliphatic polyester polyols and polyether polyols, such as are much described in the literature. The polyethers and/or polyesters used as polyols (A21) may be either linear or branched, although unbranched, linear polyols are preferred. Moreover, polyols (A21) may also possess substituents, such as halogen atoms. As polyols (A21) particular preference is given to polypropylene glycols having masses Mn of 4000 to 20 000, because these polyols have comparatively low viscosities even for high chain lengths.

As polyols (A21) it is also possible to use hydroxyalkyl- or aminoalkyl-terminated polysiloxanes of the general formula [3]

Z-R⁶—[Si(R⁵)₂—O—]ₙ—Si (R⁵)₂—R⁶-Z [3]

in which
R⁵ is a hydrocarbon radical having 1 to 12 carbon atoms, preferably methyl radicals,
R⁶ is a branched or unbranched hydrocarbon chain having 1-12 carbon atoms, preferably n-propyl,
n is a number from 1 to 3000, preferably a number from 10 to 1000,
Z is an OH group or a group NHR⁷, and
R⁷ is hydrogen, an optionally halogen-substituted cyclic, linear or branched C₁ to C₁₈ alkyl or alkenyl radical or a C₆ to C₁₈ aryl radical.

As will be appreciated, the use of any desired mixtures of the various types of polyol is also possible.

In one preferred version of the invention low molecular mass diols, such as glycol, the various regioisomers of propanediol, of butanediol, of pentanediol or of hexanediol, for example, are also present in the polyol component (A21). The use of these low molecular mass diols leads to an increase in the urethane-group density of the prepolymer (A) and hence to an improvement of mechanical properties in the cured compositions (M) preparable from these prepolymers. Low molecular mass diamino compounds or hydroxyalkylamines, 2-(methylamino)ethanol for example, may also be present in the polyol component.

As di- or polyisocyanates (A22) for preparing the prepolymers (A) it is possible in principle to use all customary isocyanates such as are much described in the literature. Examples of common diisocyanates (A22) are diisocyanatodiphenylmethane (MDI), both in the form of crude or technical MDI and in the form of pure 4,4′ or 2,4′ isomers or mixtures thereof, tolylene diisocyanate (TDI) in the form of its various regioisomers, diisocyanatonaphthalene (NDI), isophorone diisocyanate (IPDI), perhydrogenated MDI (H-MDI) or else hexamethylene diisocyanate (HDI). Examples of polyisocyanates (A22) are polymeric MDI (P-MDI), triphenylmethane triisocyanate or isocyanurate triisocyanates or biuret triisocyanates. All di- and/or polyisocyanates (A22) can be used individually or else in mixtures. It is preferred, however, to use exclusively diisocyanates. If the UV stability of the prepolymers (A) or of the cured materials (M) produced from these prepolymers is important because of the particular application, then it is preferred to use aliphatic isocyanates as component (A22).

The preparation of the prepolymers (A) may take place as a one-pot reaction through a simple combining of the components described, it being possible if desired to add a catalyst and/or to operate at an elevated temperature. Owing to the relatively highly exothermic nature of these reactions it may be advantageous to add the individual components in succession in order to allow the volume of heat evolved to be controlled more effectively. Separate purification or other working-up of the prepolymer (A) is generally unnecessary.

The concentrations of all isocyanate groups involved in all reaction steps, and of all isocyanate-reactive groups, and also the reaction conditions, are chosen here preferably such that all of the isocyanate groups are consumed by reaction in the course of the prepolymer synthesis. The finished prepolymer (A) is therefore isocyanate-free. In one preferred embodiment of the invention the concentration ratios and the reaction conditions are chosen such that virtually all of the chain ends (>80% of the chain ends, more preferably >90% of the chain ends) of the prepolymers (A) are terminated with alkoxysilyl groups of the general formula [2].

In one preferred embodiment of the invention NCO-terminated prepolymers (A2) are reacted with an excess of the silanes (A1) of the invention. The excess amounts to preferably 20-400%, more preferably 50-200%. The excess silane can be added to the prepolymer at any desired point in time, but preferably the silane excess is added during the actual synthesis of the prepolymers (A).

The reactions between isocyanate groups and isocyanate-reactive groups that occur during the preparation of the prepolymers (A) may if desired be accelerated by means of a catalyst. In that case it is preferred to use the same catalysts also listed below as curing catalysts (C). Where appropriate it is even possible for the preparation of the prepolymers (A) to be catalyzed by the same catalysts which later on, in the curing of the finished prepolymer blends, act as curing catalyst (C). This has the advantage that the curing catalyst (C) is already in the prepolymer (A) and need no longer be added separately during the compounding of a finished prepolymer blend (M). As will be appreciated, instead of one catalyst combinations of two or more catalysts may also be employed.

The prepolymers (A) are preferably compounded with further components to form mixtures (M). In order to achieve rapid curing of these compositions (M) at room temperature it is possible where appropriate to add a curing catalyst (C). As already mentioned, suitable compounds here include the organotin compounds that are customarily used for this purpose, such as dibutyltin dilaurate, dioctyltin dilaurate, dibutyltin diacetylacetonate, dibutyltin diacetate or dibutyltin dioctoate etc. In addition it is also possible to use titanates, e.g., titanium(IV) isopropoxide, iron(III) compounds, e.g., iron(III) acetylacetonate, or else amines, e.g., triethylamine, tributylamine, 1,4-diazabicyclo[2.2.2]octane, 1,8-diazabicyclo[5.4.0]undec-7-ene, 1,5-diazabicyclo[4.3.0]non-5-ene, N,N-bis(N,N-dimethyl-2-aminoethyl)methylamine, N,N-dimethylcyclohexylamine, N,N-dimethylphenylamine, N-ethylmorpholinine, etc. Organic or inorganic Brønsted acids as well, such as acetic acid, trifluoroacetic acid or benzoyl chloride, hydrochloric acid, phosphoric acid, the monoesters and/or diesters thereof, such as butyl phosphate, (iso)propyl phosphate, dibutyl phosphate, etc., are also suitable as catalysts [C]. In addition it is also possible here, however, to employ numerous further organic and inorganic heavy metal compounds and also organic and inorganic Lewis acids or bases. Moreover, the crosslinking rate may also be increased further or tailored precisely to the particular demand through the combination of different catalysts or of catalysts with different cocatalysts. Preference is given in this case to mixtures (M) which contain exclusively heavy metal-free catalysts (C).

The use of prepolymers (A) with silane termini of the general formula [2] has the particular advantage, moreover, that in this way it is also possible to prepare prepolymers (A) which contain exclusively ethoxysilyl groups, i.e. silyl groups of the general formula [2] in which R² is an ethyl radical. The reactivity of these compositions (M) with respect to moisture is such that they cure at a sufficiently high rate even without tin catalysts, despite the fact that ethoxysilyl groups are generally less reactive than the corresponding methoxysilyl groups. Hence tin-free systems are possible even with ethoxysilane-terminated polymers (A). Polymer blends (M) of this kind containing exclusively ethoxysilane-terminated polymers (A) possess the advantage that on curing they release only ethanol as a cleavage product. They represent a preferred embodiment of this invention.

The prepolymers (A) are used preferably in blends (M) which, furthermore, additionally contain low molecular mass alkoxysilanes (D). These alkoxysilanes (D) may take on a number of functions. For example they may serve as water scavengers—that is, they are intended to scavenge any traces of moisture present and so to increase the storage stability of the corresponding silane-crosslinking compositions (M). As will be appreciated, their reactivity to traces of moisture must be at least comparable with that of the prepolymer (A). Particularly suitable water scavengers are therefore highly reactive alkoxysilanes (D) of the general formula [4]

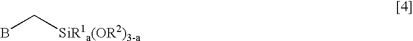

where
B is an OH, SH or NH₂ group or a group OR⁷, SR⁷, NHR⁷ or N(R⁷)₂ and
R¹, R² and a are as defined for the general formula [1].

One particularly preferred water scavenger here is the carbamatosilane in which B is a group R⁴O—CO—NH, where R⁴ and R⁷ are as defined above.

Furthermore, the low molecular mass alkoxysilanes (D) may also serve as crosslinkers and/or reactive diluents. Suitable in principle for this purpose are all silanes possessing reactive alkoxysilyl groups via which they can be incorporated into the three-dimensional network which forms as the polymer blend (M) cures. These alkoxysilanes (D) may contribute to an increase in the network density and hence to an improvement in the mechanical properties, such as the tensile strength, of the cured composition (M). Moreover, they may also lower the viscosity of the corresponding prepolymer blends (M). Examples of suitable alkoxysilanes (D) in this function are alkoxymethyltrialkoxysilanes and alkoxymethyldialkoxyalkylsilanes. Alkoxy groups in this context are preferably methoxy and ethoxy groups. Moreover, the inexpensive alkyltrimethoxysilanes, such as methyltrimethoxysilane, and also vinyl- or phenyltrimethoxysilane, and also their partial hydrolysates, may also be suitable.

The low molecular mass alkoxysilanes (D) may also serve as adhesion promoters. Here it is possible in particular to use alkoxysilanes which possess amino functions or epoxy functions. Examples that may be mentioned include γ-aminopropyltrialkoxysilanes, γ-[N-aminoethylamino]propyltrialkoxysilanes, γ-glycidyloxypropyltrialkoxysilanes, and all silanes of the general formula [4] in which B is a group containing nitrogen.

Finally, the low molecular mass alkoxysilanes (D) may even serve as curing catalysts or cocatalysts.

Particularly suitable for this purposes are all basic aminosilanes, such as all aminopropylsilanes, N-aminoethylaminopropylsilanes, and also all silanes of the general formula [4] where B is a group containing nitrogen.

The alkoxysilanes (D) can be added to the prepolymers (A) at any desired point in time. Insofar as they do not possess NCO-reactive groups, they may even be added during the synthesis of the prepolymers (A). In that case it is possible per 100 parts by weight of prepolymer (A) to add up to 100 parts by weight, preferably 1 to 40 parts by weight, of a low molecular mass alkoxysilane (D).

Furthermore, blends of the alkoxysilane-terminated prepolymers (A) are customarily admixed with fillers (E). These fillers (E) lead to a considerable improvement in the properties of the resultant blends (M). In particular, both the tensile strength and the breaking extension can be increased considerably through the use of appropriate fillers.

Suitable fillers (E) here are all materials of the kind much described in the prior art. Examples of fillers are nonreinforcing fillers, i.e., fillers having a BET surface area of up to 50 m²/g, such as quartz, diatomaceous earth, calcium silicate, zirconium silicate, zeolites, calcium carbonate, metal oxide powders, such as aluminum, titanium, iron or zinc oxides and/or their mixed oxides, barium sulfate, calcium carbonate, gypsum, silicon nitride, silicon carbide, boron nitride, glass powders and polymeric powders; reinforcing fillers, i.e., fillers having a BET surface area of at least 50 m²/g, such as pyrogenic silica, precipitated silica, carbon black, such as furnace black and acetylene black, and high-BET-surface-area silicon-aluminum mixed oxides; fibriform fillers, such as asbestos, and also polymeric fibers.

The stated fillers may have been rendered water repellent, such as by treatment with organosilanes or organosiloxanes or by etherification of hydroxyl groups to alkoxy groups, for example. It is possible to use one kind of filler, and it is possible to use a mixture of at least two fillers.

The fillers (E) are employed preferably in a concentration of 0-90% by weight relative to the finished blend (M), particular preference being given to concentrations of 30-70% by weight. In one preferred application use is made of filler combinations (E) which in addition to calcium carbonate also include pyrogenic silica and/or carbon black.

The blends (M) comprising the prepolymers (A) may also, furthermore, include small amounts of an organic solvent (F). The purposes of this solvent is to lower the viscosity of the uncrosslinked compositions (M). Suitable solvents (F) include in principle all solvents and also solvent mixtures. As solvents (F) it is preferred to use compounds which have a dipole moment. Particularly preferred solvents possess a heteroatom having free electron pairs which are able to enter into hydrogen bonds. Preferred examples of such solvents are ethers such as tert-butyl methyl ether, esters, such as ethyl acetate or butyl acetate, and alcohols, such as methanol, ethanol, n- and tert-butanol. The solvents (F) are used preferably in a concentration of 0-20% by volume relative to the finished prepolymer mixture (M) including all fillers (E), particular preference being given to solvent concentrations of 0-5% by volume.

As further components the polymer blends (M) may include conventional auxiliaries, such as water scavengers and/or reactive diluents other than components (D), and also adhesion promoters, plasticizers, thixotropic agents, fungicides, flame retardants, pigments, etc. Additionally, light stabilizers, antioxidants, free-radical scavengers, and further stabilizers may be added to the compositions (M). For generating the particularly desired profiles of properties, both of the uncrosslinked polymer blends (M) and of the cured compositions (M), such additions are preferred.

For the polymer blends (M) there exist numerous different applications in the areas of adhesives, sealants, including joint sealants, surface coatings, and in the production of moldings. In other words, polymer blends (M) can be employed not only in pure form but also in the form of solutions or dispersions.

All of the above symbols in the above formulae have their definitions in each case independently of one another. In all formulae the silicon atom is tetravalent.

Unless indicated otherwise, all amounts and percentages are by weight, all pressures are 0.10 MPa (abs.), and all temperatures are 20° C.

### EXAMPLE 1

### Preparation of Diethyl N-Methyl(Dimethoxymethylsilyl)-aspartate

A 250 mL reaction vessel with stirring and cooling means is charged under nitrogen with 67.6 g (0.50 mol) of aminomethyldimethoxymethylsilane. Added dropwise to the silane over the course of 3.5 h are 86.1 g (0.50 mol) of diethyl maleate. The reaction mixture is cooled to 30° C. After the end of the addition it is stirred at room temperature for a further 16 h and then the reaction mixture is subjected to fractional distillation. This gives 125.6 g (0.41 mol) of diethyl N-methyl(dimethoxymethylsilyl)aspartate as a colorless liquid (b.p. 107° C./0.25 mbar).

### EXAMPLE 2

### Preparation of diethyl N-methyl(diethoxymethylsilyl)-aspartate

A 250 mL reaction vessel with stirring and cooling means is charged under nitrogen with 81.6 g (0.50 mol) of aminomethyldiethoxymethylsilane. Added dropwise to the silane over the course of 3.5 h are 86.1 g (0.50 mol) of diethyl maleate. The reaction mixture is cooled to 30° C. After the end of the addition it is stirred at room temperature for a further 16 h and then the reaction mixture is subjected to fractional distillation. This gives 140.5 g (0.42 mol) of diethyl N-methyl(diethoxymethylsilyl)aspartate as a colorless liquid (b.p. 109° C./0.28 mbar).

### EXAMPLE 3

### Preparation of diethyl N-methyl(trimethoxysilyl)-aspartate

A 250 mL reaction vessel with stirring and cooling means is charged under nitrogen with 75.1 g (0.50 mol) of aminomethyltrimethoxysilane. Added dropwise to the silane over the course of 3.5 h. are 86.1 g (0.50 mol) of diethyl maleate. The reaction mixture is cooled to 30° C. After the end of the addition it is stirred at room temperature for a further 16 h and then the reaction mixture is subjected to fractional distillation. This gives 145.5 g (0.45 mol) of diethyl N-methyl(trimethoxysilyl)aspartate as a colorless liquid (b.p. 134° C./0.47 mbar).

### EXAMPLE 4

### Determining the Stability of -Aminosilanes in the Presence of Methanol

General instructions: the α-aminosilane is dissolved in methanol-D4 (10% by weight). The resulting solution is subjected repeatedly to ¹H NMR-spectroscopic measurement. The half-life (t_{1/2}) of the α-aminosilane is determined employing the integrals of the methylene spacer —HN—CH₂—Si(O)R₃ in the undecomposed α-aminosilane (δ approximately 2.2 ppm) and also the integral of the methyl group —NHCH₂D obtained as a decomposition product (cleavage of the Si—C bond) (δ approximately 2.4 ppm).

Half-life of diethyl N-methyl(dimethoxymethylsilyl)-aspartate (inventive) in the presence of methanol: t_{1/2}=4 weeks

Half-life of diethyl N-methyl(diethoxymethylsilyl)-aspartate (inventive) in the presence of methanol: t_{1/2}=5 weeks

Half-life of diethyl N-methyl(trimethoxymethylsilyl)-aspartate (inventive) in the presence of methanol: t_{1/2}=5 weeks

Half-life of aminomethylmethyldimethoxysilane (not inventive) in the presence of methanol: t_{1/2}=6 h

### EXAMPLE 5

### Preparation of a Prepolymer (A)

A 250 mL reaction vessel with stirring, cooling, and heating means is charged with 152 g (16 mmol) of a polypropylene glycol having an average molecular weight of 9500 g/mol (Acclaim® 12200 from Bayer AG) and this initial charge is dewatered at 80° C. for 30 minutes under reduced pressure. Subsequently the heating is removed and, under nitrogen, 2.16 g (24 mmol) of 1,4-butanediol, 12.43 g (56 mmol) of isophorone diisocyanate, and 80 mg of dibutyltin dilaurate (corresponding to a tin content of 100 ppm) are added. The mixture is stirred at 80° C. for 60 minutes. The NCO-terminated polyurethane prepolymer obtained is thereafter cooled to 75° C. and admixed with 10.35 g (32 mmol) of diethyl N-methyl(trimethoxymethylsilyl)-aspartate and the mixture is stirred at 80° C. for 60 minutes. IR spectroscopy reveals that there are no longer any isocyanate groups in the resulting prepolymer mixture.

### EXAMPLE 6

### Preparation of a Prepolymer (A)

A 250 mL reaction vessel with stirring, cooling, and heating means is charged with 152 g (16 mmol) of a polypropylene glycol having an average molecular weight of 9500 g/mol (Acclaim® 12200 from Bayer AG) and this initial charge is dewatered at 80° C. for 30 minutes under reduced pressure. Subsequently the heating is removed and, under nitrogen, 2.16 g (24 mmol) of 1,4-butanediol, 12.43 g (56 mmol) of isophorone diisocyanate, and 80 mg of dibutyltin dilaurate (corresponding to a tin content of 100 ppm) are added. The mixture is stirred at 80° C. for 60 minutes. The NCO-terminated polyurethane prepolymer obtained is thereafter cooled to 75° C. and admixed with 20.7 g (64 mmol) of diethyl N-methyl(trimethoxymethylsilyl)-aspartate and the mixture is stirred at 80° C. for 60 minutes. IR spectroscopy reveals that there are no longer any isocyanate groups in the resulting prepolymer mixture.

1-7. (canceled)

8. An aminomethyl-functional alkoxysilane of the formula (1) 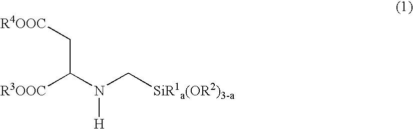
where
R¹ is an optionally halogen-substituted hydrocarbon radical,
R² is an alkyl radical having 1-6 carbon atoms or a ω-oxaalkyl-alkyl radical having in all 2-10 carbon atoms,
R³ is an optionally substituted hydrocarbon radical,
R⁴ is an optionally substituted hydrocarbon radical, and
a is 0, 1 or 2.

9. A process for preparing a prepolymer having end groups of the formula (2) 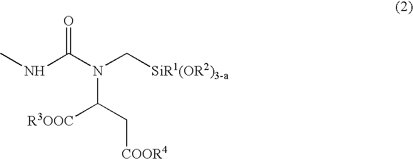
by reacting at least one alkoxysilane of claim 8
a) with one or more isocyanate-terminated prepolymers, or
b) with at least one prepolymer precursor containing NCO groups to give an intermediate containing end groups of the formula (2), the intermediate containing end groups of the formula (2) being reacted in further step(s) to give a finished prepolymer.

10. A prepolymer having end groups of the formula (2) 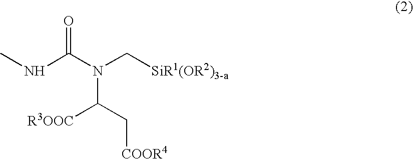
where
R¹ is an optionally halogen-substituted hydrocarbon radical,
R² is an alkyl radical having 1-6 carbon atoms or a ω-oxaalkyl-alkyl radical having in all 2-10 carbon atoms,
R³ is an optionally substituted hydrocarbon radical,
R⁴ is an optionally substituted hydrocarbon radical, and
a is 0, 1 or 2.

11. The prepolymer of claim 10, which is isocyanate-free.

12. An alkoxysilane of claim 1 wherein R² is an ethyl group.

13. The prepolymer of claim 10 wherein R² is an ethyl group.

14. The prepolymer of claim 11 wherein R² is an ethyl group.

15. The alkoxysilane of claim 8, wherein R¹ groups are methyl, ethyl or phenyl groups.

16. The alkoxysilane of claim 12, wherein R¹ groups are methyl, ethyl or phenyl groups.

17. The prepolymer of claim 10, wherein R¹ groups are methyl, ethyl, or phenyl groups.

18. The prepolymer of claim 11, wherein R¹ groups are methyl, ethyl, or phenyl groups.

19. The prepolymer of claim 13, wherein R¹ groups are methyl, ethyl, or phenyl groups.

20. A moisture curable composition comprising one or more prepolymers of claim 10.

21. A moisture curable composition comprising one or more prepolymers of claim 11.

22. A moisture curable composition comprising one or more prepolymers of claim 13.

23. A moisture curable composition comprising one or more prepolymers of claim 17.
